(19) United States
(12) Patent Application Publication
(10) Pub. No.: US 2001/0037254 A1
(43) Pub. Date: Nov. 1, 2001

(54) System and method for assisting a customer in purchasing a commodity using a mobile device

(76) Inventor: Adi Glikman, Ramat Gan (IL)

Correspondence Address: MORGAN, LEWIS & BOCKIUS, 1800 M STREET NW, WASHINGTON, DC, 20036-5869, US

(21) Appl. No.: 09/801,786

(22) Filed: Mar. 9, 2001

Related U.S. Application Data
(60) Provisional application No. 60/187,998, filed on Mar. 9, 2000.

(51) Int. Cl. G06F 17/60

(52) U.S. Cl. 705/26

(57) ABSTRACT

A system and method for assisting a customer in purchasing a commodity using a mobile device in online and physical worlds that includes visiting a vendor; selecting a commodity of the vendor that the customer desires to purchase; providing the vendor with mobile device information associated with the mobile device; sending a message to the mobile device associated with the mobile device information, wherein the message includes the purchase amount; confirming the purchase amount by a mobile user of the mobile device; and billing a mobile account associated with the mobile device for the purchase amount.

### RELATED APPLICATIONS

This application claims priority from U.S. Provisional Patent Application No. 60/187,998, filed on Mar. 9, 2000.

### BACKGROUND OF THE INVENTION

1. Field of the Invention

The present invention relates to the purchase of a commodity, such as a product, service, and/or information, and more particularly, to a system and method for assisting a customer in purchasing a commodity using a mobile device.

2. Discussion of the Related Art

Most vendors in both the physical and online worlds, such as the Internet, provide several payment options for purchasing commodities, such as products, services, and/or information.

The phrases “physical world” and “online world” in the present specification, respectively, refer to the existing infrastructure for consummating transactions in a physical sense (purchasing commodities in a vendor's physical store or via telephone, for example) and in an online sense (e-commerce, purchasing commodities via vendor's web sites, for example). Common payment options include checks, money orders, individual accounts, credit cards, and debit cards. However, each of these conventional payment options has one or more drawbacks.

Checks or money orders, for example, are typically used in both the online and physical worlds. However, these payment options have a drawback in that the online vendors require the customer to mail in a check or money order before providing the customer with the commodity. As a result, customers must wait for several days until the vendor receives and clears the payment before the vendor will provide the customer with the commodity.

Another payment option includes an individual account with each vendor. In this case, the vendor will provide the customer with the commodity and subsequently bill the customer. A drawback to this form of payment is that customers must open and maintain a separate account with each vendor. Moreover, each vendor must maintain a billing department for processing the bills and payments, as well as a collection department for collection.

Yet another payment option includes credit cards, such as VISA™ and MASTERCARD™, and/or debit cards. These payment options have several drawbacks. First, most customers are reluctant to provide their credit or debit card information for purchases in the online world due to security and confidentiality concerns. Furthermore, the use of credit cards or debit cards may be cost prohibitive for small purchases, such as an amount as small as $1.00; or the vendor may require a minimum purchase amount, such as a minimum amount of $10.00. Moreover, most issuers of credit cards do not issue a credit card to children or customers with poor or unestablished credit. As a result, this portion of the market is untapped by vendors selling commodities with credit card payment options.

Other payment options, such as electronic cash, electronic checks, or similar forms are too cumbersome and novel. Moreover, these options arouse the same security concerns among customers as using their credit or debit cards.

Accordingly, a need exists for an improved system and method for purchasing commodities in both the physical and online worlds.

### SUMMARY OF THE INVENTION

Accordingly, the present invention is directed to a system and method that substantially obviate one or more of the problems due to limitations and disadvantages of the related art. In particular, it is an object of the present invention to provide a system and method for assisting the customer in purchasing a commodity using a mobile device.

Additional features and advantages of the invention will be set forth in the description that follows, and will be apparent from the description, or may be learned by practice of the invention. The objects and other advantages of the invention will be realized and attained by the structure particularly pointed out in the written description and claims hereof as well as the appended drawings.

To achieve these and other advantages in accordance with the purpose of the invention, as embodied and broadly described herein, the present invention provides a system for assisting a customer in purchasing a commodity by using a mobile device, the system comprising a customer device that accesses a vendor device through a computer network; a processing device that generates a web page to be displayed on the customer device prompting the customer for information on the mobile device, and upon receiving the information transmitting a purchase amount in a message to the mobile device through a carrier network; a computer network connected to the carrier network for connecting the customer device, the vendor device, and the processing device; and means for selecting a commodity from the vendor device, for connecting the vendor device to the processing device, for prompting the customer to confirm the purchase amount upon transmitting the message to the mobile device, and for charging the purchase amount to a mobile account associated with the mobile device if the purchase amount is confirmed.

In another aspect, the present invention provides a system for assisting a customer in purchasing a commodity by using a mobile device, the system comprising a customer device that accesses a vendor device through a computer network; the vendor device that generates a web page prompting the customer for information on the mobile device and upon receiving the information transmits a purchase amount in a message to a mobile device through a carrier network; a computer network connected to the carrier network for connecting the customer device and the vendor device; and means for selecting a commodity from the vendor device, for prompting the customer to confirm the purchase amount upon transmitting the message to the mobile device and for charging the purchase amount to a mobile account associated with the mobile device if the purchase amount is confirmed.

In another aspect, the present invention provides a method for assisting a customer in purchasing a commodity by using a mobile device, the method comprising the steps of using a customer device to access a vendor device through a computer network; selecting a commodity on the vendor device for purchase; connecting the vendor device to a processing device and generating a web page in the processing device that prompts the customer for information regarding the mobile device; entering requested information on the mobile device; transmitting a purchase amount in a message to the mobile device through a carrier network; prompting the user to confirm the purchase amount; and charging the purchase amount to a mobile account associated with the mobile device if the purchase amount is confirmed.

In yet another aspect, the present invention provides a system for assisting a customer in purchasing a commodity by using a mobile device, the system comprising a vendor device that allows the customer to visit the vendor's on-line store, select a commodity on the vendor on-line store for purchase, and choose a mobile device payment option; a processing device that generates a web page prompting the customer for information on the mobile device, and upon receiving the information transmits a purchase amount in a message to a mobile device through a carrier network; a computer network connected to the carrier network for connecting the customer device, the vendor device, and the processing device; and means for connecting the vendor device to the processing device, for prompting the customer to confirm the purchase amount upon transmitting the message to the mobile device, and for charging the purchase amount to a mobile account associated with the mobile device if the purchase amount is confirmed.

In yet a further aspect, the present invention provides a system for assisting a customer in purchasing a commodity using a mobile device in online and physical worlds, comprising a customer device for accessing a vendor device through a computer network to select particular commodities for purchase; a carrier network that is connected to a computer network; a processing device, including a user database, for generating a web page that prompts a customer for information; a mobile device for entering information requested on the web page and thereby purchasing the selected commodity; and means for connecting the vendor device to the processing device, wherein the vendor device and the processing device bill a mobile account associated with the mobile device for a purchase amount of the selected commodity.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an overall system block diagram of a preferred embodiment of the present invention for use in the online world;

FIG. 2 is a block diagram illustrating the components of the customer device 100 shown in FIG. 1;

FIG. 3 is a block diagram illustrating the components of the vendor device 300 shown in FIG. 1;

FIG. 4 is a block diagram illustrating the components of the processing device 400 shown in FIG. 1; 15 FIG. 5 is a block diagram illustrating the components of the carrier network 500 shown in FIG. 1;

FIG. 6 is a block diagram of a preferred embodiment of the system of the present invention;

FIG. 7 is a block diagram of another embodiment of the system of the present invention;

FIG. 8 is an overall system block diagram of another embodiment of the present invention for use in the online world;

FIG. 9 is a block diagram illustrating a third embodiment of the system of the present invention;

FIG. 10 is an overall system block diagram of an embodiment of the present invention for use in the physical world;

FIG. 11 is an overall system block diagram of another embodiment of the present invention for use in the physical world;

FIG. 12 is a flow chart depicting one embodiment of an operation of the present invention;

FIG. 13 is a flow chart depicting the payment process of the present invention;

FIGS. 14A-14G are examples of sample messages that may be displayed to a customer; and

FIGS. 15A-D are examples of sample messages that may be displayed to the mobile user.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts, and a redundant detailed description will be omitted.

The present invention provides a system and method to assist a customer in purchasing a commodity using a mobile device, such as a mobile phone. For example, with the present invention, a customer may purchase a commodity in the physical world or the online world, such as the Internet, and the purchase amount may be charged to the customer's mobile account.

The system and method of the present invention are not limited to any particular product or service, customer, vendor, or mobile device. The customer may buy any type of commodity, including but not limited to goods, products, services, information, and/or service plans. The commodity includes those that sell for money and/or those that are free. Customers as defined herein in connection with the system of the present invention may include, but are not limited to, consumers, businesses, or government entities. Vendors as described herein in connection with the present invention may include, but are not limited to, merchants, service providers, government entities, and non-profit organizations. Mobile devices in the present invention may include, but are not limited to mobile phones, pagers, two-way radios, smartphones, and communicators. Moreover, the mobile device may be owned, leased, or used by either the customer or a person known to the customer, such as the customer's parent or child. The components of the system will be described now, followed by a description of the operation of the system.

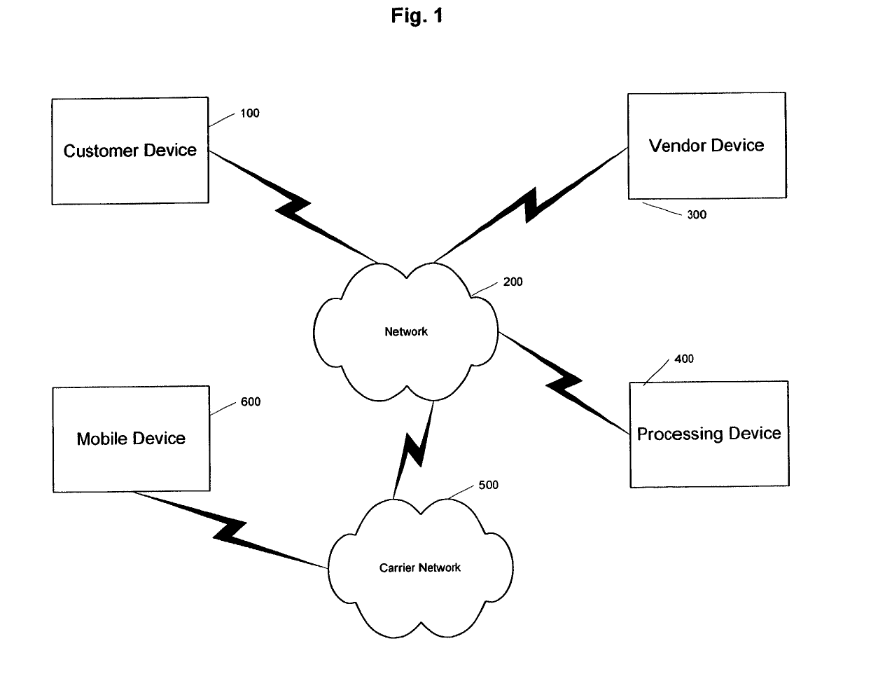

FIG. 1 is an overall system block diagram of a preferred embodiment of the present invention for use in the online world. With reference to FIG. 1, the system of the present invention includes a customer device 100, a vendor device 300, and a processing device 400, all of which are interconnected by a network 200. A carrier network 500 is also connected to the network 200. For example, the carrier network may be a wireless network, such as the Bell Atlantic Mobile™ wireless network. The system also includes a mobile device 600, such as a mobile phone, which is connected to the carrier network 500. The customer device 100 accesses the vendor device 300 through the network 200. Network 200 may be any type of computer network, such as the Internet, an Intranet, or an Extranet, for example. Access devices, such as phone lines, cable lines, fiber optic cables, or wireless communication systems may be used to access the network 200, as known and understood in the art. One or more types of access devices may be used to connect to the network 200. For example, the customer device 100 may access the network 200 using a wireless communication system, whereas the vendor device 300 may access the network 200 using fiber optic cables. These as well as other network and access device configurations are known to those skilled in the art, and are also within the scope of this invention.

An example of the operation of the system of the present invention will be described now for illustrative purposes. According to the present invention, a customer uses a customer device 100, such as a personal computer, to access the vendor device 300, such as a web server hosting the vendor's web site, through the network 200, such as the Internet. Once connected to the vendor's web site, the customer selects particular commodities that the customer desires to purchase. Then, the vendor device 300 connects to the processing device 400. The processing device 400 generates a web page, which prompts the customer for information on the mobile device 600. The mobile device 600 may be a mobile phone owned by the customer or, alternatively, owned by someone who knows the customer. The customer may be asked for information, such as a unique subscriber identification number and/or the name of the carrier associated with the mobile phone. Once the customer enters this information, the processing device 400 sends the purchase amount in a message to the mobile phone through the carrier network 500. The user of the mobile phone is prompted to confirm the purchase amount and if confirmed, the purchase amount is charged to the mobile account associated with the mobile device 600. At the same time, the customer is presented with a web page displayed on the customer device 100 notifying the customer of the status of the transaction.

The above example is intended to be illustrative of the present invention as opposed to limiting it in any manner. Other examples will be known to those skilled in the art, and are within the scope of the present invention.

The present invention uses a carrier network 500 that connects both the online world, such as the Internet, and the wireless world. As shown in FIG. 5, the carrier network 500 includes a gateway 510 and a wireless network 520. Accordingly, if a mobile user needs to access the online world, the mobile user may use the mobile device 600 to send a request to the wireless network, which sends the request to the gateway 510. The gateway 510 translates the request received from the user into an appropriate form and forwards it to network 200. On the other hand, if an online user or system in the online world desires to send information to the mobile user, the online user or system may send the information through the Internet to the gateway 510, which sends the information to the wireless network 520 and eventually to the mobile device 600. The gateway 510 again performs the necessary translation such that the mobile device 600 can receive and display the transmitted information. In order for mobile users to send and receive requests to and from the online world, the mobile user needs client software, such as a micro-browser, for example. The mobile device 600 is not limited to use in accessing information via the online world as described above. Instead, the mobile device 600 may access other information and services, as long as the provider of these information and services uses a compatible standard. One common standard used by many carrier networks is the Wireless Application Protocol (WAP).

WAP is an open and global specification that allows users of mobile devices to easily access and interact with information and services instantly. WAP is compatible with standard data link protocols and provides a complete set of network communication programs comparable to and supportive of the Internet set of protocols, for example. As a result, WAP is compatible with most wireless networks, such as Cellular Digital Packet Data (CDPD), Code-Division Multiple Access (CDMA), Global System for Mobile communication (GSM), Personal Handyphone System (PHS), Time Division Multiple Access (TDMA), and Digital Enhanced Cordless Telecommunications (DECT), for example. WAP is compatible with existing Internet standards, such as XML, UDP, and IP, and is based on Internet standards, such as HTTP and TLS. In particular, Wireless Markup Language (WML), which is included within WAP, is a language that allows information from web pages to be presented to users of mobile devices via a carrier network. Many vendors have developed products that utilize the WAP standard. For example, Phone.com's UP.BROWSER™ is a WAP-compatible micro-browser and Phone.com's UP.LINK™ is a gateway that supports WAP. Many WAP gateways, such as UP.LINK™, translate information received from a web site that is in the HTML format to the WML format before sending that information to the mobile device 600.

Instead of WAP, a carrier network may alternatively utilize other standards, such as Short Message Service (SMS) and SIM (Subscriber Identity Module) Toolkit, for example. SMS may be used for sending messages to mobile devices that utilize a GSM network. SIM Toolkit is a smartcard centric method of deploying applications that applies to GSM and SMS, for example.

Using the SIM Toolkit standard, a carrier network may send information to a SIM card, which is inserted in the mobile device 600. Other carrier network configurations, protocols, and standards are known to those skilled in the art, and are also within the scope of the present invention.

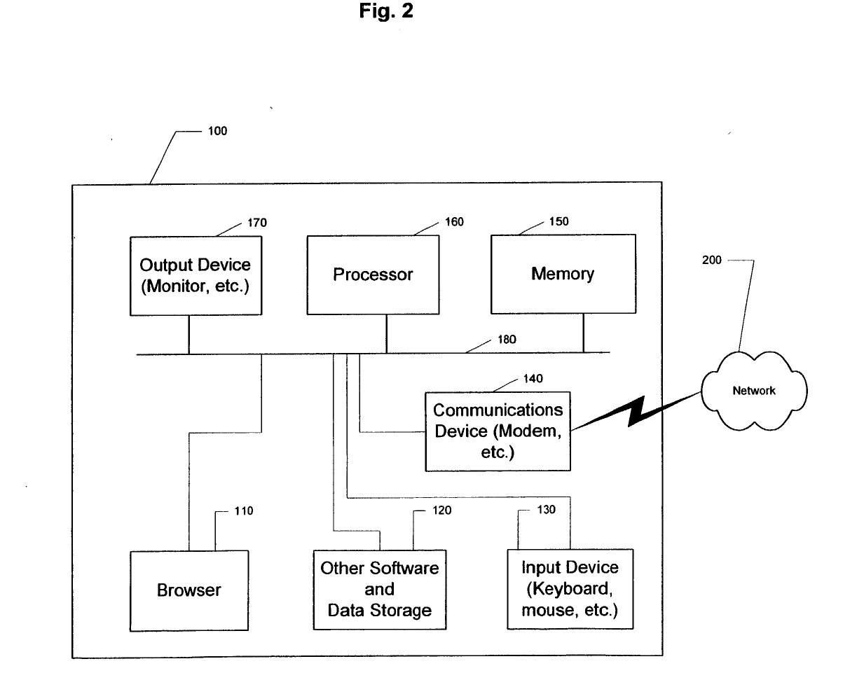

As described in the foregoing, the customer device 100 is used to access the vendor device 300. The customer device 100 may be a personal computer, a handheld computer, or any similar device known to those skilled in the art. As shown in FIG. 2, the customer device 100 may include a browser 110, such as a World Wide Web browser like NETSCAPE NAVIGATOR™ and/or INTERNET EXPLORER™; other software and data storage 120; at least one input device 130, such as a keyboard or a mouse; at least one communications device 140, such as a modem; at least one processor 160; at least one memory 150, and at least one output device 170, such as a monitor; all of which may communicate with each other via a communication bus 180, for example. The memory 150 may be Random Access Memory (RAM), Read Only Memory (ROM), or both. Other customer devices and their components are known to those skilled in the art, and are also within the scope of the present invention.

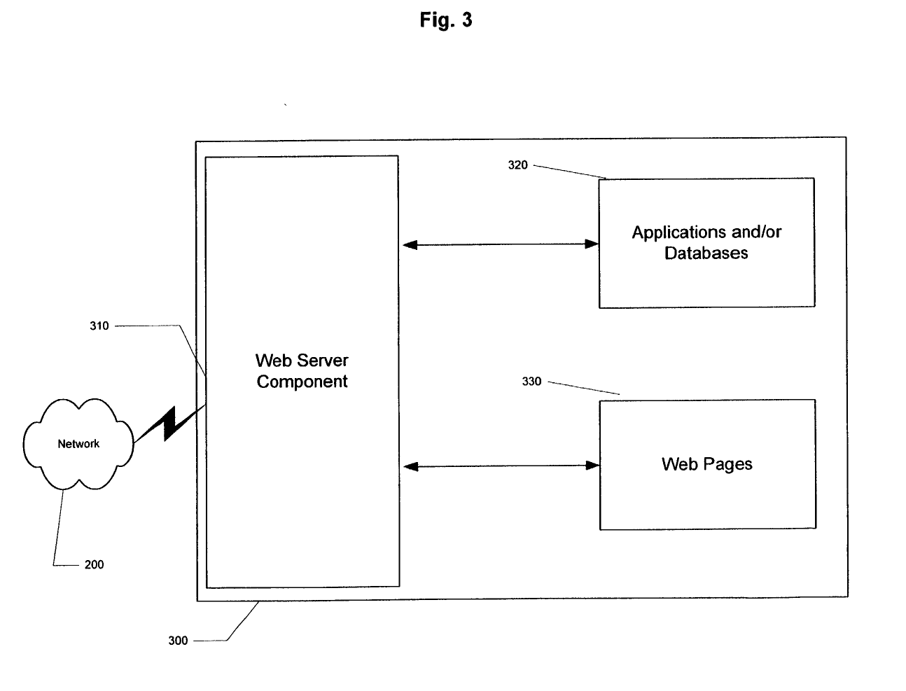

The vendor device 300 shown in FIG. 1 will now be described. As shown in FIG. 3, the vendor device 300 may include a web server component 310, applications and/or databases 320, and web pages 330. The vendor device 300 also may include at least one administrative interface for administering the various components. The web server component 310 may be used to host the vendor's web site. The web pages 330 may contain information about the commodities that the vendor's sell as well as other information about the vendor. These pages may be static, dynamic, or a combination of both as is well known in the art. The applications and/or databases 320 may be used to store and generate information about the vendor's commodities, such as pricing information, for example. When the customer first visits the vendor's web site, the customer may be presented with a web page welcoming the customer to the vendor's web site. Then, the customer may be presented with a web page that has commodity information, which was generated using the applications and/or databases 320. Other devices and their components are known to those skilled in the art, and are also within the scope of the present invention. For example, depending on the type of customers that visit the vendor's web site and the equipment and networks used to access the web site, the vendor may choose to display web pages in HTTP, WML, or some other format. Moreover, some vendors may have separate Uniform Resource Locator's (URL's) for their HTML and WML entry points, or use a single URL to dynamically provide either HTML or WML content according to the requestor's browser type. Some of the components shown in FIG. 3 will be further described in detail below along with the description of the operation of the preferred embodiments of the present invention.

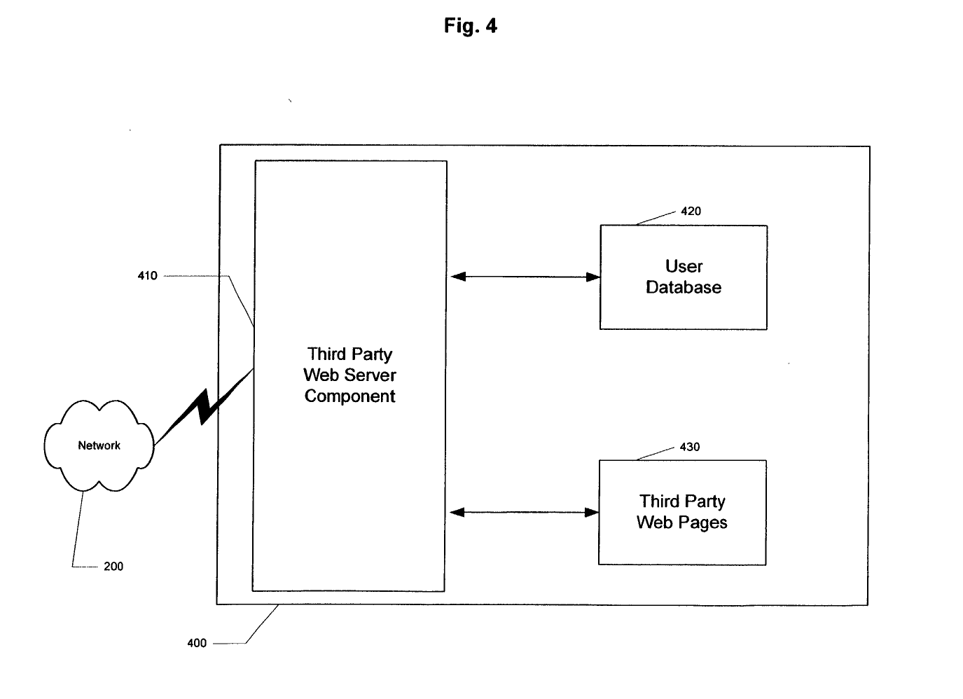

As explained in the foregoing description, after the customer selects the commodities that the customer desires to purchase, the vendor device 300 may transfer the customer to the processing device 400, which is managed by a third party. As illustrated in FIG. 4, the processing device 400 may include a third party web server component 410, a user database 420, and third party web pages 430. The processing device 400 also may include an administrative interface to administer its various components. The operation of the third party web server component 410 and third party web pages 430 is similar to the operation of the web server component 310 and the web pages 330 described above in connection with FIG. 3 and thus, is not again described in detail. The user database 420 includes information associated with a particular mobile device, such as a mobile phone. For example, the user database 420 may include information about the owner or user of the mobile phone.

An example of the operation of the user database will now be described for illustrative purposes. The vendor device 300 sends information, such as a purchase amount, to the processing device 400. The processing device 400 may send a message to the customer asking the customer for a mobile device identification number and/or carrier information. For example, the mobile device may be a mobile phone owned by the customer or a person known to the customer. In this case, the processing device 400 may send a message asking the customer to enter this unique subscriber identification number and the name of the carrier associated with their mobile phone. After the customer enters this information, the user database 420 may be queried via a look-up table arrangement, for example, to find the user associated with the information entered by the customer. Once a match is found in the database, the customer is presented with the name of the user or owner of the mobile phone, and is asked to verify this information. Once the customer verifies the information, a message is sent to the mobile user via their mobile phone asking the user for permission to charge the purchase amount to their mobile account associated with the mobile device 600 via the carrier network 500. The above example is intended to be illustrative of the present invention as opposed to limiting it in any manner.

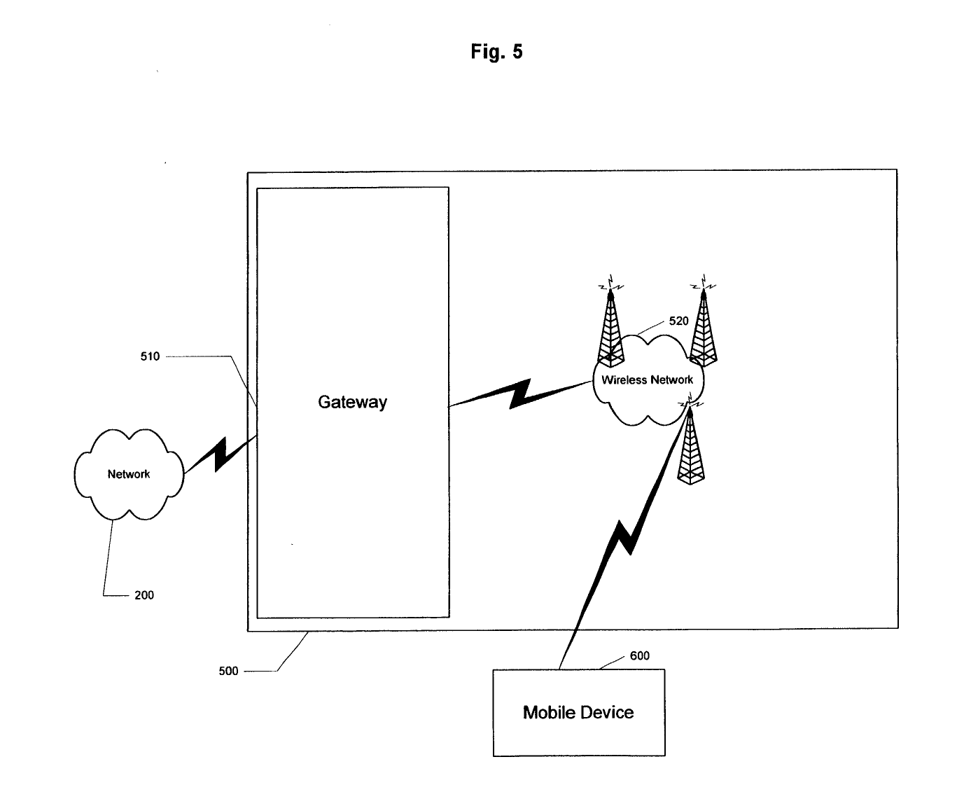

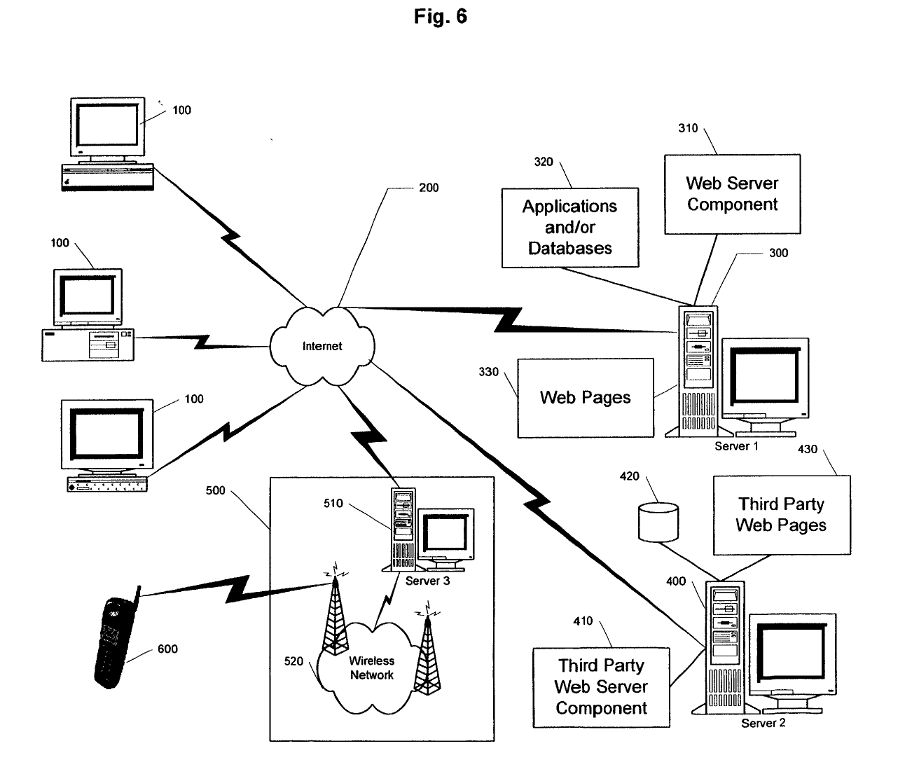

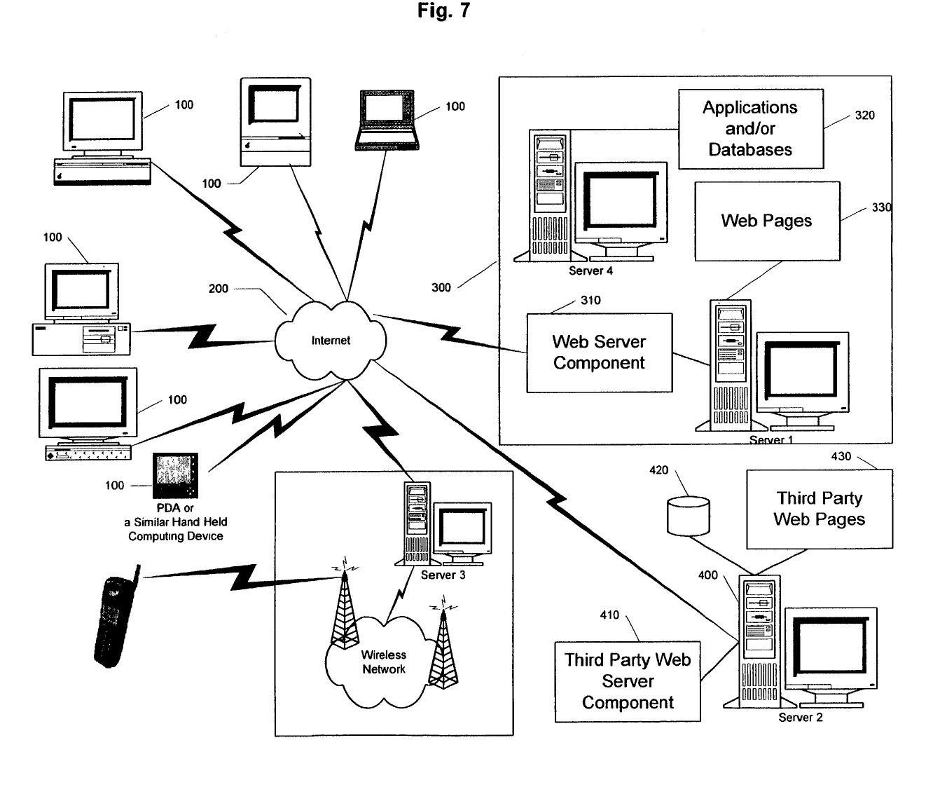

Two examples of how the system of the present invention may be implemented will now be described with reference to FIGS. 6 and 7. As shown in FIGS. 6 and 7, a customer may use a desktop or a workstation computer as the customer device 100. This computer may contain all the components shown in FIG. 2 as well as other components known and understood in the art. Server 1 may be used as the vendor device 300. This server may include a web server component 310, applications and/or databases 320, and web pages 330. Vendor device 300 and customer device 100 are connected to each other via a Network 200, such as the Internet. The customer may use a communications device 140 in his computer to connect to the Internet and access the web site hosted by the web server component 310 on the Server 1 using a browser 110 and standard Internet protocols. Server 2 represents the processing device 400 and is also connected to the Internet. Server 2 includes a third party web server component 410, user database 420, and third party web pages 430. The carrier network 500 includes Server 3 that functions as the gateway 510 and a wireless network 520. Server 3 may include, for example, Phone.com's UP.LINK™ WAP gateway. Finally, mobile phone 600 may be used as the mobile device and be connected to the wireless network 520. The mobile phone 600 may also have, for example, Phone.com's UP.BROWSER™, a WAP-compatible micro-browser for sending and receiving information.

FIG. 7 shows a second implementation, which is similar to FIG. 6, but differs at least with regard to the arrangement of the vendor device 300. In FIG. 7, the vendor device 300 includes two servers, instead of one. Moreover, these two servers may be connected to each other, for example, in a Local Area Network (LAN). The provision of additional servers assists in load balancing and improves reliability in connections with customers. The web server component 310 may run on Server 1 and the other components of the vendor device 300, such as the applications and/or databases 320. Web pages 330 may run on Server 4, for example. Depending on the amount of traffic to the vendor's web site, more servers may be added if needed. The present invention is not limited to the above examples, as other implementation configurations are known to those skilled in the art, and are also within the scope of the present invention.

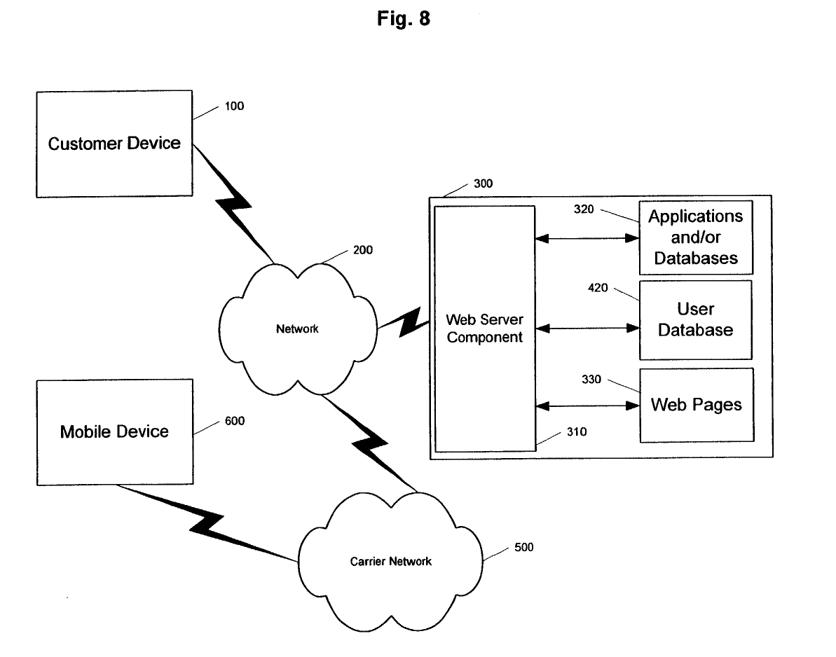

Another embodiment of the present invention for use in the online world will now be described with reference to FIG. 8. FIG. 8 is similar to the embodiment shown in FIG. 1, but differs at least with regard to the arrangement of the vendor device 300. The embodiment shown in FIG. 8 does not have a processing device 400. Instead, the user database 420 is part of the vendor device 300. In this embodiment, the vendor device 300 completes the purchasing process instead of sending transaction information to a processing device 400.

An example of how this embodiment may be implemented will be described now by referring to FIG. 9. FIG. 9 is similar to FIG. 6, but differs at least with regard to the arrangement of the processing device 400 and the vendor device 300. This implementation does not use a separate processing device 400. Instead, the user database 420 is configured as a part of Server 1, which represents the vendor device 300.

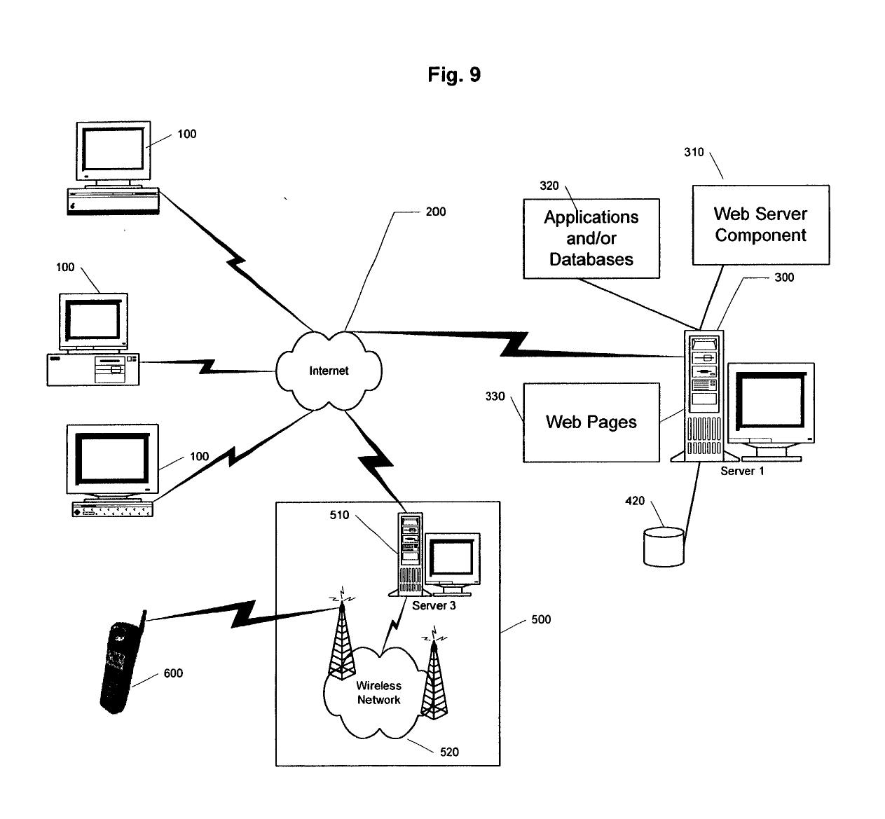

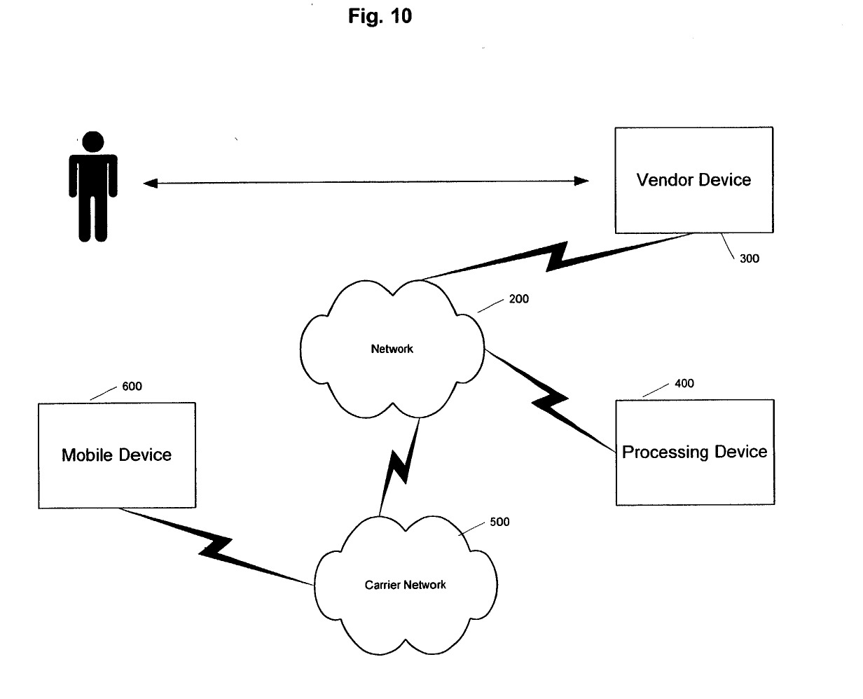

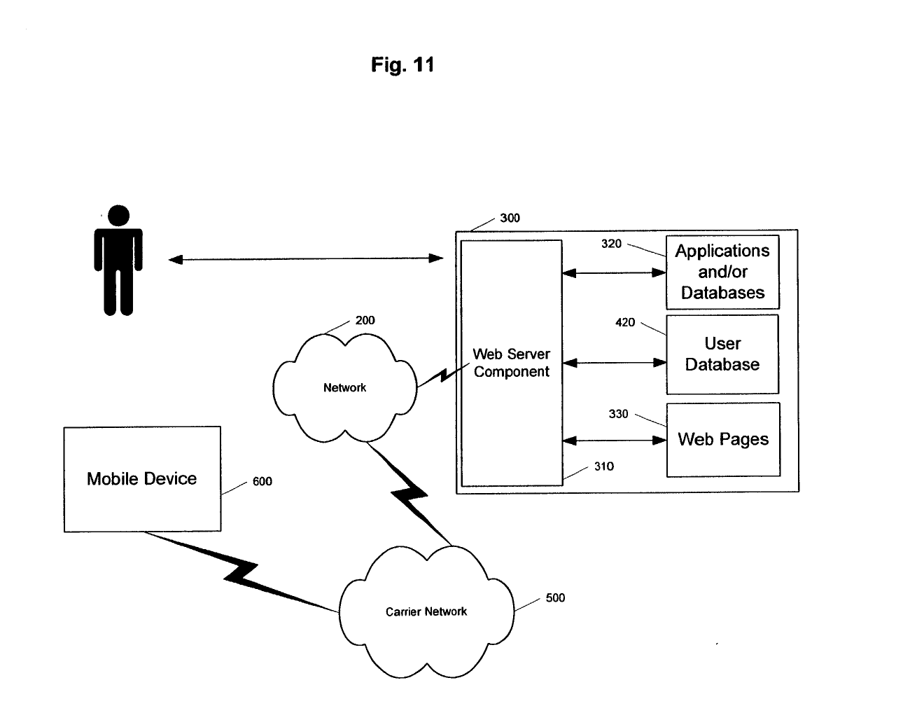

FIGS. 10 and 11 illustrate other embodiments of the present invention. Although similar to the embodiments shown in FIGS. 1 and 8, these embodiments illustrate applications of the instant invention involving transactions in which the vendor is accessed via the physical world instead of exclusively online. In the embodiment of FIG. 10, the customer does not need a customer device 100. Instead, the customer may visit the vendor's physical store or may call the vendor's store to purchase the commodities. The other components, such as the network 200, vendor device 300, processing device 400, carrier network 500, and the mobile device 600, may be similar to the components that are used in the previously-described embodiments, or may have different configurations. For example, the vendor may modify his existing equipment, such as a cash register, to be compatible within vendor device 300.

FIG. 11 illustrates another embodiment of the present invention, which is similar to FIG. 10, but which differs at least in the configuration of the vendor device 300 and processing device 400. This embodiment also is similar to the embodiment shown in FIG. 8, where the processing device 400 and vendor device 300 are one device, instead of two separate devices. Due to the similarities between these arrangements, this embodiment is not described in further detail herein.

The “physical world” embodiments of the present invention are not limited to the configurations shown in FIGS. 10 and 11. For example, a vendor that sells commodities in both the physical and the online worlds may choose to configure the vendor device 300 such that the device may be used in both the online and physical worlds. Other configurations are known to those skilled in the art, and are also within the scope of the present invention.

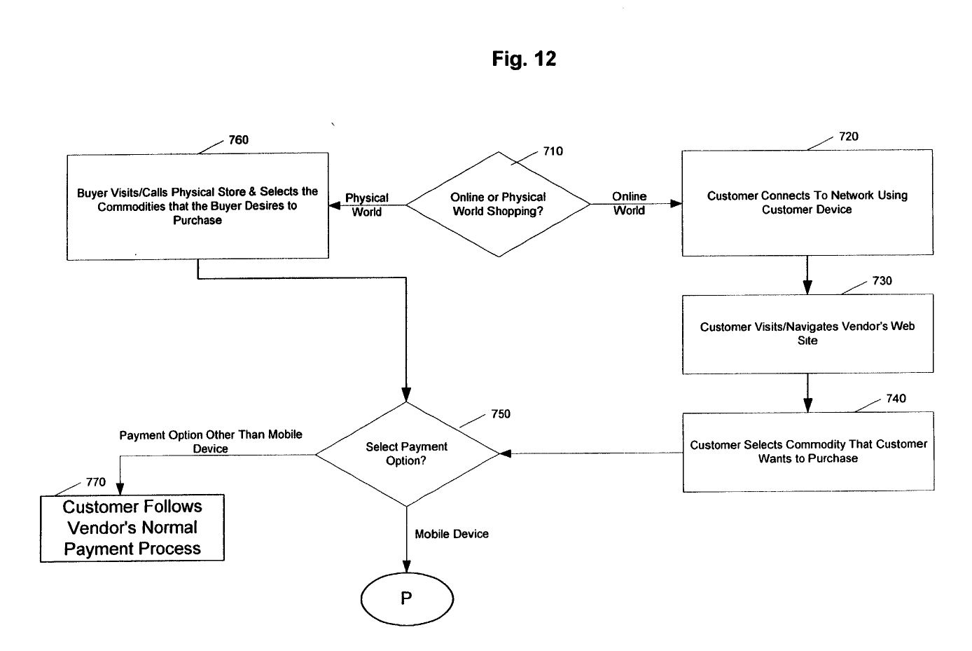

With reference to FIGS. 12-15, the operation of the system in both the online and physical worlds will now be described. In step 710, a customer decides between shopping in the online world and the physical world. If the customer decides to shop in the physical world, the customer visits a physical store, selects the commodities that the customer desires to purchase, and proceeds to the payment counter, as shown in step 760. At the payment counter, the customer is asked to choose between the payment options accepted by the vendor, as shown in step 750. For example, the payment counter may be the checkout counter in the physical store. In step 760, the customer also may contact a physical store via telephone instead of visiting the store. If the customer does contact the physical store via telephone, the customer again selects the commodities that the customer desires to purchase and once all the commodities have been selected, the customer is asked to choose between the payment options accepted by the vendor, as indicated by step 750.

Conversely, if the customer decides to shop online in step 710, the customer connects to network 200 using the customer device 100, as indicated by step 720. After connecting, the customer visits and/or navigates the vendor's web site, which is hosted by the web server component 310, as indicated by step 730. The customer may browse the web pages 330 and may select the commodities that the customer desires to purchase, as indicated by a step 740. After the customer selects particular commodities, the customer is asked to choose between the payment options accepted by the vendor, as indicated by step 750.

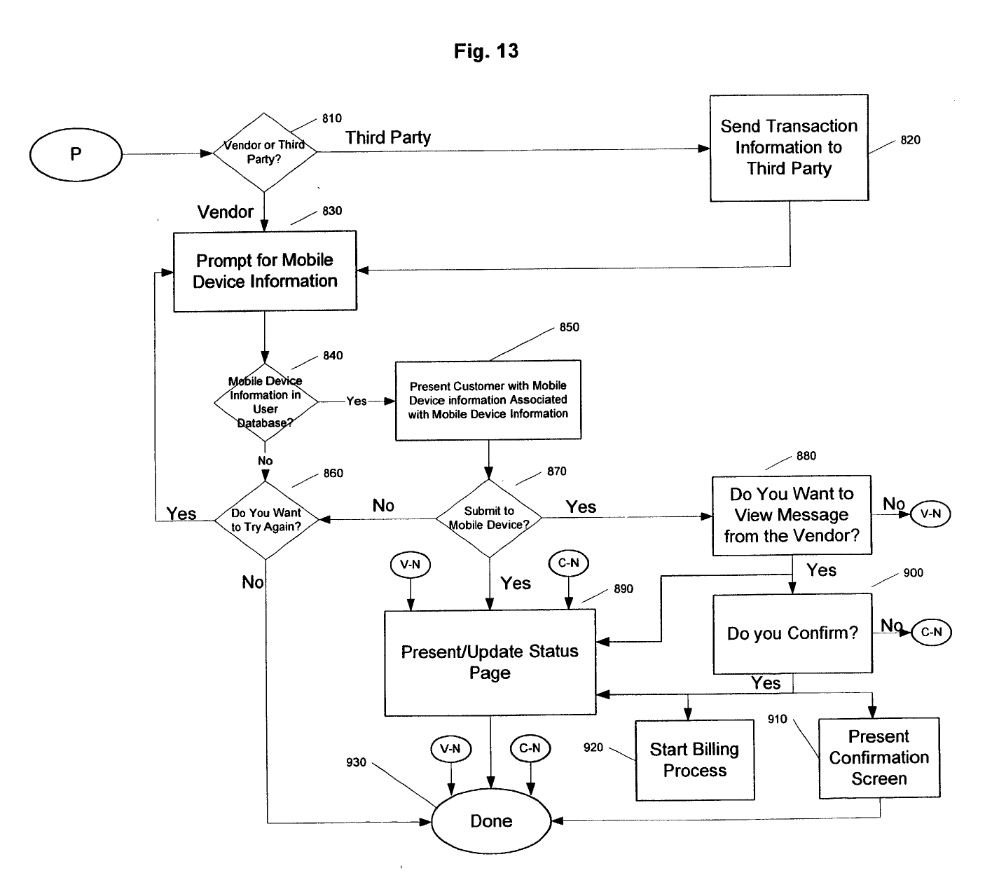

For example, in the step 750, if a vendor provides three payment options: mobile device 600, VISA™/MASTERCARD™, and Debit Card, the customer may be presented with these three payment options. If the customer chooses any payment option other than the mobile device 600, the customer follows the vendor's normal payment process for the selected payment option, as indicated by a step 770. On the other hand, if the customer selects mobile device 600, the payment is processed using the system and method of the present invention, as indicated by branch P in FIGS. 12 and 13. The rest of this payment process will now be described with emphasis on the payment process with respect to the online world. A person skilled in the art will know how to modify the process described in the following description for use in the physical world and thus, such modifications are within the scope of the present invention.

Referring to FIG. 13, after the customer chooses to pay with the mobile device 600, the vendor either processes the payment using the vendor device 300 or sends the transaction information to the processing device 400, which may be operated by a third party, as indicated by steps 810 and 820. The embodiment shown in FIG. 8, for example, is used if the vendor processes the payment. Conversely, if the processing device 400 processes the payment, the embodiment shown in FIG. 1 is used. The transaction information may include, but is not limited to, the vendor's name, information about the commodities that the customer desires to purchase, the total amount of the purchase, and the URL address of a status page. The status page indicates the status of the transaction to the customer and will be described in further detail later. Moreover, the transaction information also may include information associated with the mobile device 600. The vendor name, information about the commodities that the customer desires to purchase, the total amount of a purchase, and the URL address of the status page may be automatically generated by the applications and/or databases 320. The web pages 330 may include a status page, for example. The information associated with the mobile device 600 may include, but is not limited to, the unique subscriber identification number as well as the name of the carrier utilized by the mobile user. The mobile device information may include an optional personal identification number (pin) assigned to the mobile user for security purposes to prevent unauthorized use of the mobile device 600. The customer may be prompted for the mobile device information after the customer selects the mobile device payment option in step 750 or the mobile device information may be retrieved from the customer device 100. For example, the mobile device information may be stored as a cookie on the customer device 100 after the customer enters the mobile device information for the first time. A cookie is a small amount of information that a web site, for example, copies to the customer device 100. The cookie, for example, may assist a web site in identifying a customer the next time the customer visits the web site. The use of cookies is generally well known in the network communications arts and is accordingly not further described herein.

Regardless of where the payment is processed, the customer may be prompted for mobile device information, as indicated by step 830. Alternatively, the mobile device information may have been previously entered, as explained in the foregoing description, and thus, step 830 may not be needed. Step 830 also may not be needed if the mobile device information is retrieved from the customer device 100, as explained in the foregoing description. Next, the user database 420 is queried using the mobile device information. If a match is not found in the user database 420, the customer is given another opportunity to enter the associated mobile device information, as indicated by steps 840 and 860. If the customer chooses to try again, the customer is asked to enter the mobile device information, as indicated by steps 860 and 830. Conversely, if the customer does not want to try again, the process is complete, as indicated by step 930.

If a match is found in the user database 420, the customer may be presented with other information associated with the mobile device 600, as indicated by steps 840 and 850. The other information may include the name of the user or owner of the mobile device 600. The customer also may be asked to confirm that the presented mobile device information is correct and whether a message should be sent to the mobile device associated with the mobile device information, as indicated by step 870. If the information is not correct, the customer may be given the opportunity to try again, as indicated by steps 860 and 870. If the customer does not want to try again, the customer's transaction is cancelled and the customer is done with the process, as shown by step 930.

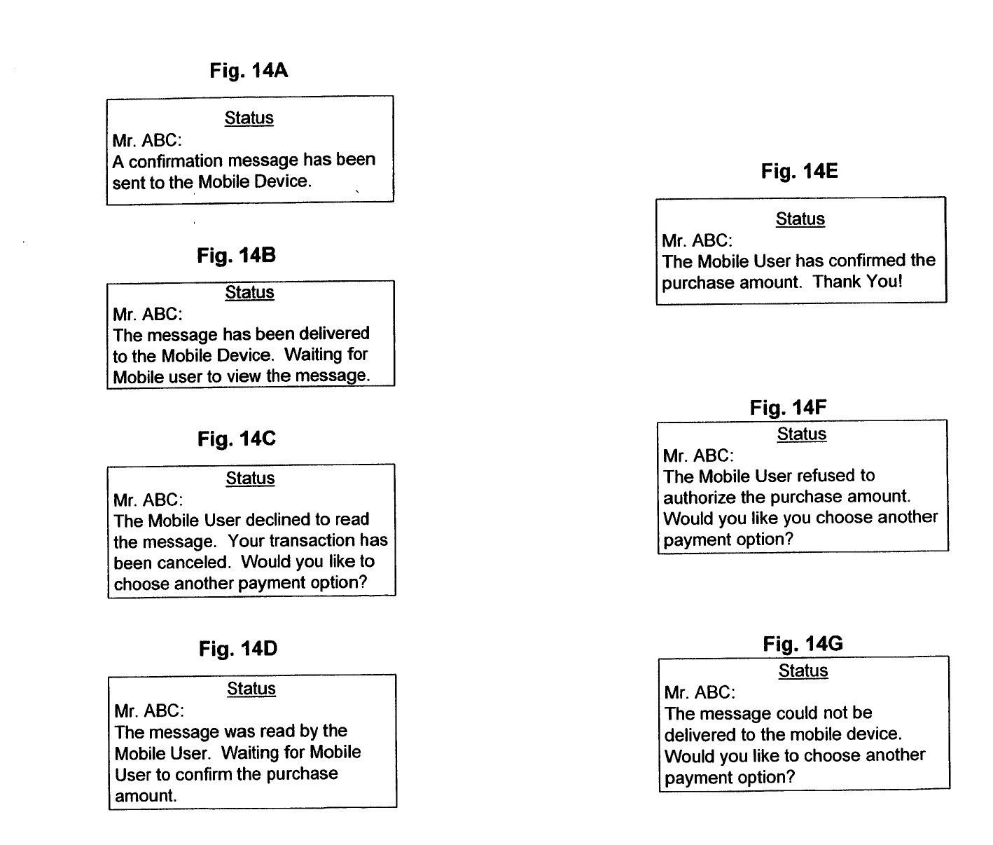

Conversely, if the mobile device information is correct and the customer desires to proceed with the transaction, the customer may select “Yes,” for example, to proceed with the payment process. Next, depending on the embodiment being used, either the vendor device 300 or the processing device 400 connects to the gateway 510, which is associated with the mobile device's carrier, and sends a message to the mobile device 600, as indicated by step 880. For example, the message may be in WML or HTML format. Simultaneously, the customer is presented with a status page displayed on the customer device 100 indicating that a request has been sent to the mobile device for confirmation of the purchase amount, as indicated by step 890. A sample status page is shown in FIG. 14A. This status page may refresh automatically after a set time period, which may be set by the vendor or the third party depending on the embodiment being used, to indicate status of the transaction.

The gateway information may be stored in the user database 420 and may be retrieved along with the other mobile device information in step 840. The gateway information may include, for example, address information of the gateway such that the vendor device 300 and/or the processing device 400 can send messages to it. The gateway may utilize WAP or a similar protocol or standard, as described in the foregoing description, for example, to transfer the message to the mobile device 600 via the wireless network 520. Before transferring the message to the mobile device 600, the WAP gateway 510 translates the message into an appropriate form. For example, if the message that was sent by the vendor device 300 or the processing device 400 is in HTML format, the WAP gateway translates the message into WML format. On the other hand, if the message was in WML format, the WAP gateway may not need to translate the message and will transfer the message to the mobile device 600 through the wireless network 520.

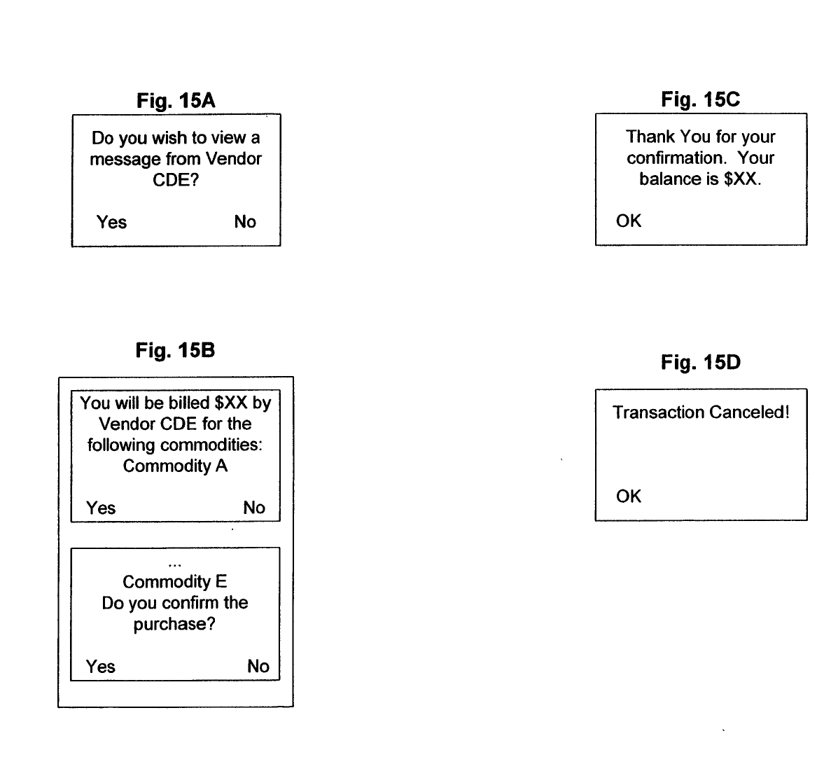

In case of any problems, such as communication problems, the payment process is cancelled and the customer is notified by updating the status page. For example, the customer may see a message similar to the one shown in FIG. 14G. The customer also may be asked to try again or select a different type of payment option, as shown in FIG. 14G. On the other hand, if there are no problems, the message is sent to the mobile device 600, and the mobile device 600 may generate an audible sound, such as a tone or a beep, for example, to alert the owner or user of the mobile device, and make the user or owner aware of the presence of the message. The message may indicate that the user or the owner of the mobile device 600 has a message from the vendor, and may ask if the user wants to view the message, as indicated by step 880. The vendor may be identified by name or by the URL address of the vendor's web site. A sample message is shown in FIG. 15A. With the delivery of the message to the mobile device 600, the status page displayed on the customer device 100 also is updated indicating that the message was delivered to the mobile device 600, as shown in FIG. 13. A sample status page indicating the delivery of the message is shown in FIG. 14B.

If the mobile user does not desire to view the message, the status page may be updated indicating that the user does not wish to view the message and the transaction is cancelled, as indicated by branch V-N in FIG. 13. The status page may be similar to the one shown in FIG. 14C and the customer may be asked to try again or select a different type of payment.

Conversely, if the mobile user decides to view the message in step 880, the status page is updated indicating that the message has been read, as shown in FIG. 13. A sample status page indicating that the message has been read is shown in FIG. 14D. Simultaneously, the mobile user also is presented with a second message asking the mobile user for permission to charge the purchase amount to the mobile account associated with the mobile device 600, as indicated by step 900. A sample of the second message is shown in FIG. 15B. The sample message may be separated into two screens and the mobile user may have to scroll to view the second screen, as shown by the two sample screens in FIG. 15B.

If the mobile user does not confirm the transaction, the transaction is cancelled and the status page is again updated with a message indicating that the mobile user did not confirm the purchase, as shown by branch C-N in FIG. 13. A sample message indicating that the transaction was cancelled is shown in FIG. 14F. The customer also may be asked to try again or select a different type of payment option, as shown in FIG. 14F. A message also is sent to the mobile device 600, a sample of which is shown in FIG. 15D, indicating that the transaction has been cancelled.

Alternatively, if the mobile user does confirm the transaction in step 900, the transaction is complete and the status page is updated with a message indicating that the transaction was confirmed, as indicated by steps 890 and 930 in FIG. 13. A sample confirmation message is shown in FIG. 14E. At the same time, a message also may be sent to the mobile user via the mobile device 600 confirming the purchase, as indicated by step 910. A sample message that may be sent to the mobile user confirming the purchase is shown in FIG. 15C. Moreover, the billing process for billing the mobile account associated with the mobile device 600 for the purchase amount also is initiated, as indicated by step 920. For example, the billing process may be based on the roaming billing process used in the wireless industry. The billing process is generally known in the art and is accordingly not further described in detail herein.

In the present invention, since the purchase amount is charged to the mobile account associated with the mobile device, which may be owned or used by the customer or a person related to the customer, such as a child of the owner, the charges appear on the account associated with the mobile device. As a result, the present invention has many advantages over the conventional payment options discussed above. The payment is confirmed almost immediately, and thus, the customer does not have to wait for the vendor to receive and clear the payment, as with the conventional methods utilizing checks and/or money orders. Moreover, the customer does not need to open an individual account with each vendor in order to purchase commodities from those vendors. Also, the limitations of using credit cards, such as the common minimum purchase requirements are obviated because the customer is billed via the mobile account. This allows for micro billing, for example, purchasing of even low-cost commodities. Furthermore, even customers who do not have credit cards may purchase a commodity using a mobile device. For example, a child may select the commodity to purchase via customer device 100, and the vendor device 300 or the processing device 400 may send a message to the parent via mobile device 600, for example, asking for confirmation for the payment amount. If the parent confirms, the child obtains the commodity and the charge appears on the parent's mobile account. Another advantage of this approach is that a parent can keep track of his or her child's purchases. Still another advantage of the present invention is that the present invention is secure because the mobile user has to confirm the purchase before the payment process is completed.

While the invention has been described in detail and with reference to specific embodiments thereof, it will be apparent to one skilled in the art that various changes and modifications can be made therein without departing from the spirit or scope thereof. Thus, it is intended that the present invention covers the modifications and variations of this invention provided they come within the scope of the appended claims and their equivalents.

What is claimed is:

1. A system for assisting a customer in purchasing a commodity by using a mobile device, the system comprising:
a customer device that accesses a vendor device through a computer network;
a processing device that generates a web page to be displayed on the customer device prompting the customer for information on the mobile device, and upon receiving the information transmitting a purchase amount in a message to the mobile device through a carrier network;
a computer network connected to the carrier network for connecting the customer device, the vendor device, and the processing device; and
means for selecting a commodity from the vendor device, for connecting the vendor device to the processing device, for prompting the customer to confirm the purchase amount upon transmitting the message to the mobile device, and for charging the purchase amount to a mobile account associated with the mobile device if the purchase amount is confirmed.

2. The system of claim 1, wherein the web page displayed on the customer device is used to notify the customer about the status of a transaction.

3. The system of claim 1, wherein the carrier network connects an on-line computer network to a wireless network, whereby the carrier network includes a gateway for receiving information from the wireless device on the wireless network, translating the information, and forwarding the information to the on-line computer network.

4. The system of claim 1, wherein the carrier network connects an on-line computer network to a wireless network, whereby the carrier network includes a gateway for receiving information from the on-line computer network, translating the information, and forwarding the information to the wireless device on the wireless network.

5. The system of claim 3, wherein the mobile device includes client software to enable users of the mobile device to send and receive requests to and from the on-line computer network.

6. The system of claim 1, wherein the information on the mobile device is a unique subscriber identification number.

7. The system of claim 1, wherein the information on the mobile device is a name of a carrier associated with the mobile device.

8. The system of claim 1, wherein the vendor device is a web server for hosting a vendor's web site, whereby the vendor device includes a plurality of applications, a plurality of databases, and a plurality of web pages.

9. The system of claim 8, wherein the plurality of web pages include at least one administrative interface for administering various components of the vendor device and include information about commodities for sale by an associated vendor.

10. The system of claim 1, wherein the processing device is managed by a third party.

11. The system of claim 1, wherein the processing device includes a web server for hosting a vendor's web site, a plurality of applications, a user database, and a plurality of web pages.

12. The system of claim 11, wherein the plurality of web pages include at least one administrative interface for administering various components of the processing device.

13. The system of claim 11, wherein the user database includes information associated with the mobile device.

14. The system of claim 13, wherein the processing device queries the user database to find a user associated with the information entered by the customer request verification if a match is found in the database.

15. The system of claim 1, wherein the carrier network is a wireless network.

16. The system of claim 1, wherein the mobile device is a mobile phone.

17. The system of claim 1, wherein the customer device is a personal computer.

18. The system of claim 1, wherein the customer device is a handheld computer.

19. The system of claim 1, wherein the customer device uses a wireless communication system to access the computer network.

20. The system of claim 1, wherein the vendor device uses fiber optic cables to access the computer network.

21. A system for assisting a customer in purchasing a commodity by using a mobile device, the system comprising:
a customer device that accesses a vendor device through a computer network;
the vendor device that generates a web page prompting the customer for information on the mobile device and upon receiving the information transmits a purchase amount in a message to a mobile device through a carrier network;
a computer network connected to the carrier network for connecting the customer device and the vendor device; and
means for selecting a commodity from the vendor device, for prompting the customer to confirm the purchase amount upon transmitting the message to the mobile device and for charging the purchase amount to a mobile account associated with the mobile device if the purchase amount is confirmed.

22. A method for assisting a customer in purchasing a commodity by using a mobile device, the method comprising the steps of:
using a customer device to access a vendor device through a computer network;
selecting a commodity on the vendor device for purchase;
connecting the vendor device to a processing device and generating a web page in the processing device that prompts the customer for information regarding the mobile device;
entering requested information on the mobile device;
transmitting a purchase amount in a message to the mobile device through a carrier network;
prompting the user to confirm the purchase amount; and
charging the purchase amount to a mobile account associated with the mobile device if the purchase amount is confirmed.

23. A system for assisting a customer in purchasing a commodity by using a mobile device, the system comprising:
a vendor device that allows the customer to visit the vendor's on-line store, select a commodity on the vendor on-line store for purchase, and choose a mobile device payment option;
a processing device that generates a web page prompting the customer for information on the mobile device, and upon receiving the information transmits a purchase amount in a message to a mobile device through a carrier network;
a computer network connected to the carrier network for connecting the customer device, the vendor device, and the processing device; and
means for connecting the vendor device to the processing device, for prompting the customer to confirm the purchase amount upon transmitting the message to the mobile device, and for charging the purchase amount to a mobile account associated with the mobile device if the purchase amount is confirmed.

24. A system for assisting a customer in purchasing a commodity using a mobile device in online and physical worlds, comprising:
a customer device for accessing a vendor device through a computer network to select particular commodities for purchase;
a carrier network that is connected to a computer network;
a processing device, including a user database, for generating a web page that prompts a customer for information;
a mobile device for entering information requested on the web page and thereby purchasing the selected commodity; and
means for connecting the vendor device to the processing device, wherein the vendor device and the processing device bill a mobile account associated with the mobile device for a purchase amount of the selected commodity.

25. The system of claim 4, wherein the mobile device includes client software to enable users of the mobile device to send and receive requests to and from the on-line computer network.

26. The system of claim 1, wherein the mobile device is a pager.

27. The system of claim 1, wherein the mobile device is a two-way radio.

28. The system of claim 1, wherein the mobile device is a smartphone.

29. The system of claim 1, wherein the mobile device is a communicator.
